(19) United States
(12) Patent Application Publication
(10) Pub. No.: US 2011/0127753 A1
(43) Pub. Date: Jun. 2, 2011

(54) LEAF SPRING ASSEMBLY AND TANDEM SUSPENSION SYSTEM

(76) Inventor: JACK GRIFFIN, Morristown, IN (US)

(21) Appl. No.: 12/938,893

(22) Filed: Nov. 3, 2010

Related U.S. Application Data
(60) Provisional application No. 61/257,891, filed on Nov. 4, 2009.

(51) Int. Cl. F16F 1/18; B60G 5/00; B60G 5/053; B60G 11/40

(52) U.S. Cl. 280/686; 267/47

(57) ABSTRACT

A leaf spring assembly and a tandem suspension system of a vehicle includes a number of leaf springs secured together so as to form a central seat adapted to be mounted to a chassis of the vehicle. The leaf spring assembly also includes a first end portion adapted to be mounted to a first axle of the vehicle and a second end portion adapted to be mounted to a second axle of the vehicle. Each leaf spring features a central arcuate section and a pair of end sections, where a thickness of the leaf spring is at a maximum in the central arcuate section and tapers down in thickness towards the pair of end sections so that a constant stress results in the material of the leaf spring when the leaf spring assembly is used in the suspension system.

### CLAIM OF PRIORITY

This application claims priority from U.S. Provisional Patent Application Ser. No. 61/257,891, filed Nov. 4, 2009, currently pending.

### FIELD OF THE INVENTION

The present invention generally relates to suspension systems for trucks and other vehicles and, more particularly, to a leaf spring assembly and a tandem suspension system using same.

### BACKGROUND

An important component of a heavy duty truck is the rear suspension system that must support the bulk of the vehicle load weight, in addition to dampening movement between the truck rear axles and chassis. The rear suspension system must also position and retain the truck rear axles with respect to the truck chassis. Truck rear suspension systems often are of the type known as “tandem suspensions”. Tandem suspensions use a single spring assembly on each side of the vehicle for supporting the load and locating two axles, which are typically drive axles. This type of suspension is also commonly referred to as a “bogie”, “chevron”, “camelback” or “single point” tandem suspension depending on what vehicle type it is used on. An example of a camelback suspension system is illustrated in U.S. Pat. No. 5,119,543 to Reilly.

Leaf spring assemblies have been satisfactorily used on trucks and other vehicles with this type of suspension for many years. A typical leaf spring assembly used in a camelback suspension system, such as the MACK truck camelback suspension, and the suspension of the Reilly '543 patent, is indicated in general at 10 in FIG. 1. The leaf spring assembly 10 of FIG. 1 is a traditional “multi-leaf” type of spring where anywhere from eight to twelve steel leaves 12 (depending on the axle centers and rated capacity) of constant thickness are stacked and stepped in length to achieve the desired rate of deflection and stresses. The multiple leaves 12 of the spring assembly 10 are secured together by a central bolt or pin 14.

While the leaf spring assembly of FIG. 1 performs well, this type of spring design creates a tremendous amount of unused and wasted material in the center clamp or seat section, indicated at 16 in FIG. 1, thereby increasing the overall weight of the suspension and the vehicle. More specifically, the multi-leaf spring assembly features an unequal stress distribution along the length of the assembly, and thereby provides excess material in the lower stressed areas.

A leaf spring assembly that overcomes the above issues is desirable. Such a leaf spring assembly would ideally also provide increased durability along with a reduction in weight. The lower weight would allow the truck to carry additional goods, thereby reducing fuel consumption per pound of goods transported. The increased durability would reduce the overall maintenance cost of the vehicle over the life of the vehicle.

### BRIEF DESCRIPTION OF THE DRAWINGS

FIG. 1 is a perspective view of a prior art leaf spring assembly of the type used in a camelback suspension;

FIG. 2 is a perspective view of an embodiment of the leaf spring assembly of the present invention;

FIG. 3 is a side elevational view of the leaf spring assembly of FIG. 2;

FIG. 4 is a side elevational view of a suspension system featuring the leaf spring assembly of FIGS. 2 and 3 mounted to the chassis of a vehicle;

FIG. 5A is a side elevational view of a top and bottom leaf of the leaf spring assembly of FIGS. 2 and 3;

FIG. 5B is a top plan view of the top and bottom leaf of FIG. 5A;

FIG. 6A is a side elevational view of a middle leaf of the leaf spring assembly of FIGS. 2 and 3;

FIG. 6B is a top plan view of the middle leaf of FIG. 6A;

FIG. 7 is an exploded perspective view of one side of a suspension system including the leaf spring assembly of FIGS. 2 and 3;

FIG. 8 is an assembled perspective view of the one side of the suspension system of FIG. 7.

### DETAILED DESCRIPTION OF EMBODIMENTS

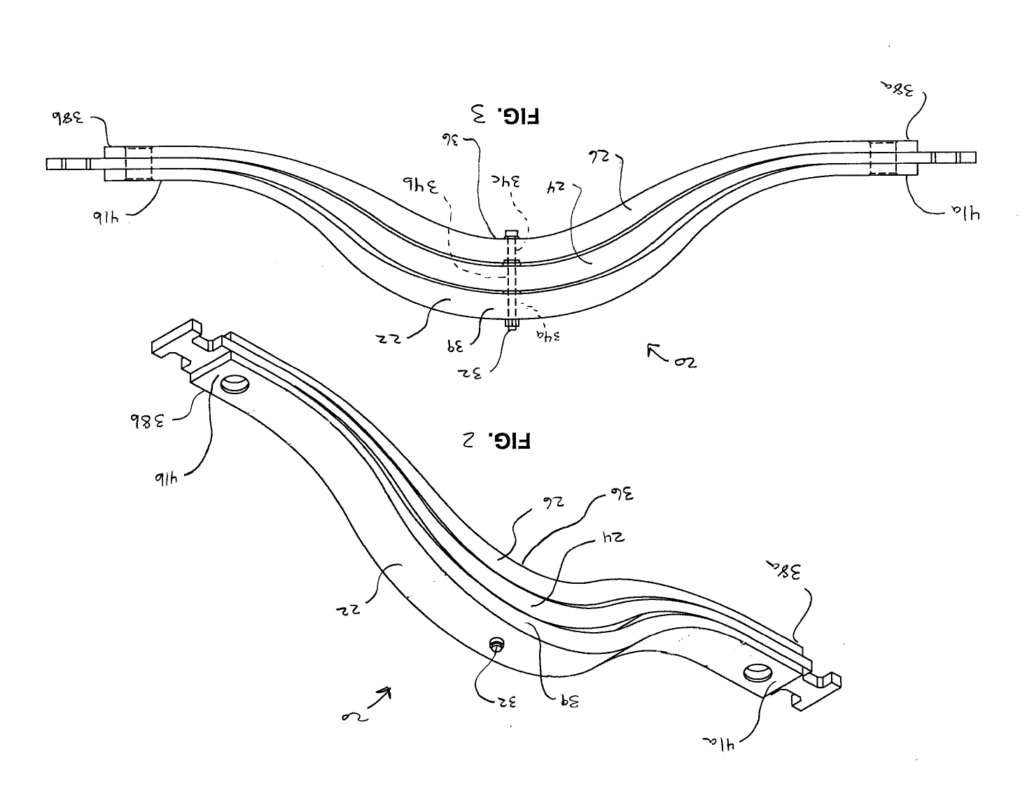

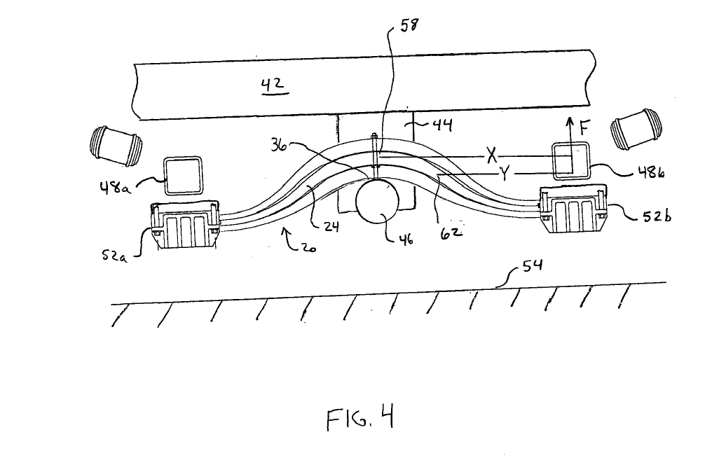

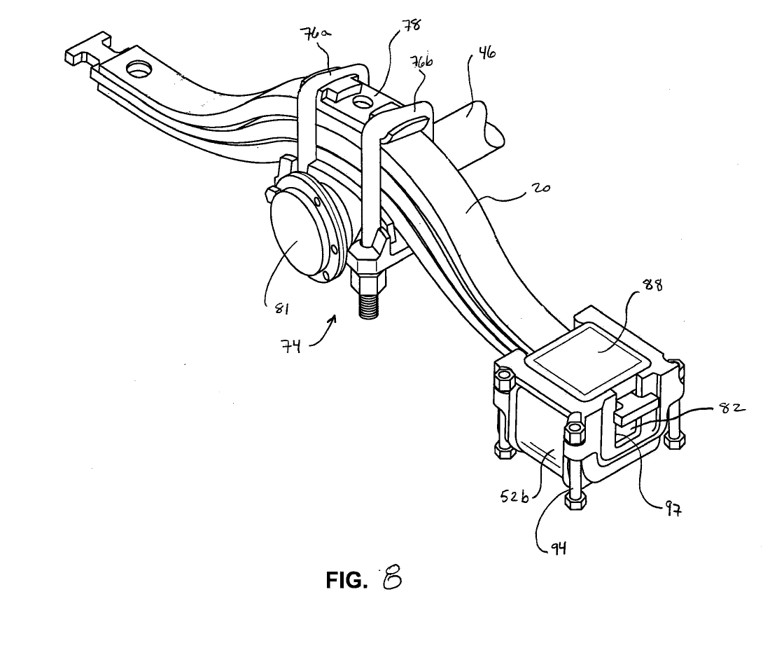

An embodiment of the leaf spring assembly of the invention is indicated in general at 20 in FIGS. 2 and 3. As illustrated in FIGS. 2 and 3, the leaf spring assembly includes a top leaf spring 22, a middle leaf spring 24 and a bottom leaf spring 26. The top, middle and bottom leaves are secured together by a central bolt 32, which passes through corresponding openings 34a, 34b and 34c (FIG. 3) formed in the leaves, until U-bolts (described below with reference to FIGS. 7 and 8), or alternative fasteners, are used to install the leaf spring assembly on the truck or other vehicle. The central bolt 32 also serves as an alignment pin during installation of the leaf spring assembly on the truck or vehicle. Alternative arrangements known in the art may be used to secure the leaf springs together. The leaf spring assembly features a seat portion 36 which, as explained in greater detail below, is mounted to the chassis of a truck or other vehicle. The spring assembly also features end portions 38a and 38b to which the truck axles are mounted, again as will be explained in greater detail below.

While a leaf spring assembly having three leaf springs is illustrated in the figures and described below, it is to be understood that the invention may use a greater or lesser number of leaf springs, depending on the application. In addition, while the leaf spring assembly is described in terms of use as part of a rear suspension system for a truck, it is to be understood that it may be used in other types of vehicle suspension systems.

As illustrated for top leaf spring 22 in FIGS. 2 and 3, each leaf spring features a central arcuate section 39, corresponding to the seat 36 of the leaf spring assembly, and generally straight end sections 41a and 41b, corresponding to end portions 38a and 38b of the leaf spring assembly. Each leaf spring preferably features a constant spring width and a profile featuring varying thickness, as illustrated in FIGS. 2-4, to provide a constant stress in the spring material along the length of each leaf spring when the used in a truck suspension system. The only variance to this preferably is in the area just outside of the seat 36 and at the end portions (38a and 38b of FIGS. 2 and 3) where the axles mount. The generally constant thickness in the area next to the seat of the leaf spring assembly is needed for blending from a standard SAE steel thickness to the equal-stress profile. The generally constant thickness in the areas at the end portions of the leaf spring assembly is needed for strength to support the axle mountings.

With reference to FIG. 4, in the leaf spring assembly 20, the portion of each leaf spring at seat 36, that is, the central arcuate section of each leaf spring, is at maximum thickness while the thickness of the leaf spring generally tapers down or decreases in a direction away from the seat towards the end portions of the leaf spring to a minimum thickness, the exceptions being the area around the seat portion and at the end portions as described above, where generally no tapering occurs. This profile reflects the stress levels placed upon the material of each leaf spring of the assembly due the cantilever beam bending effect from the upward forces acting on the end portions of the assembly via the truck rear axles.

More specifically, with reference to FIG. 4, the leaf spring assembly is attached to the frame rail 42 of the truck chassis by trunnion pivot shaft mounting bracket 44 and trunnion pivot shaft 46, the latter of which the seat 36 of the leaf spring assembly is position upon and mounted (as explained in greater detail below). The truck drive axles 48a and 48b are mounted to the end portions of the leaf spring assembly via axle clamp boxes 52a and 52b (again, as shown in greater detail below). As the truck is supported on a roadway 54 or other surface, upward forces act upon the drive axle 48b and axle clamp box 52b, as illustrated by arrow F in FIG. 4. The bending moment acting on area 58 (at the seat 36 of the leaf spring assembly) of middle leaf 24 equals the length of moment arm X multiplied by force F, while the bending moment acting on area 62 of the middle leaf 24 equals the length of moment arm Y multiplied by the force F. Because the length of moment arm Y of FIG. 4 is less than that of moment arm X, the moment, and thus stresses, acting on the lesser thickness of material in area 62 of the middle leaf spring 24 is approximately equal to the moment and stresses acting on the greater thickness of material of area 58. This same analysis applies for axle 48a and axle clamp box 52a, as well as both the top and bottom leaf springs.

The opposite ends of drive axles 48a and 48b shown in FIG. 4 are mounted to a frame rail on an opposite side of the truck in a similar fashion.

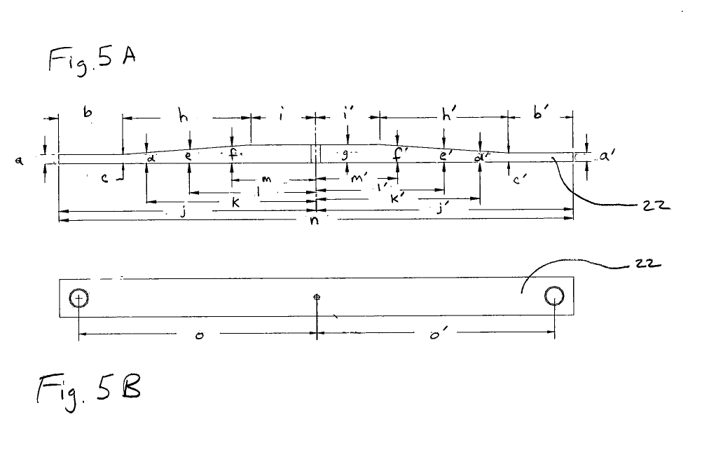

An example of suitable dimensions and a profile for the top and bottom leaf springs is illustrated for top leaf spring 22 in FIGS. 5A and 5B with reference to Table 1. For clarity, leaf spring 22 is illustrated in FIGS. 5A and 5B prior to being formed into the shape illustrated in FIGS. 2-4.

TABLE 1
Top and Bottom Spring Dimensions

| FIGS. 5A and 5B | Inches |
|---|---|
| a, a′ | 0.788 |
| b, b′ | 7 3/16 |
| c, c′ | 0.788 |
| d, d′ | 1.001 |
| e, e′ | 1.266 |
| f, f′ | 1.494 |
| g | 1.750 |
| h, h′ | 17.0 |
| i, i′ | 4.50 |
| j, j′ | 28 11/16 |
| k, k′ | 17.50 |
| l, l′ | 12.50 |
| m, m′ | 7.50 |
| n | 57⅜ |
| o, o′ | 26 5/16 |

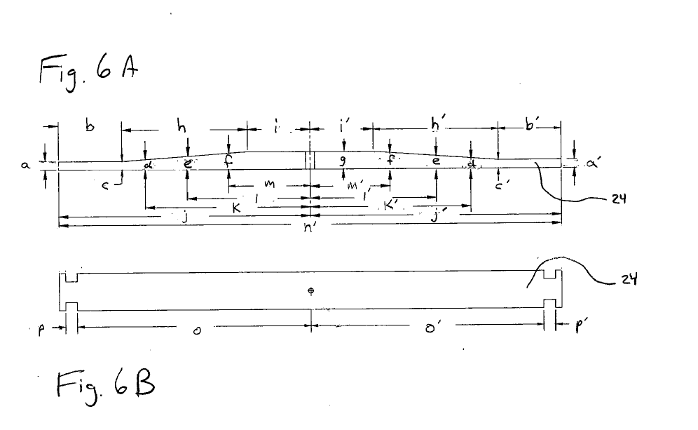

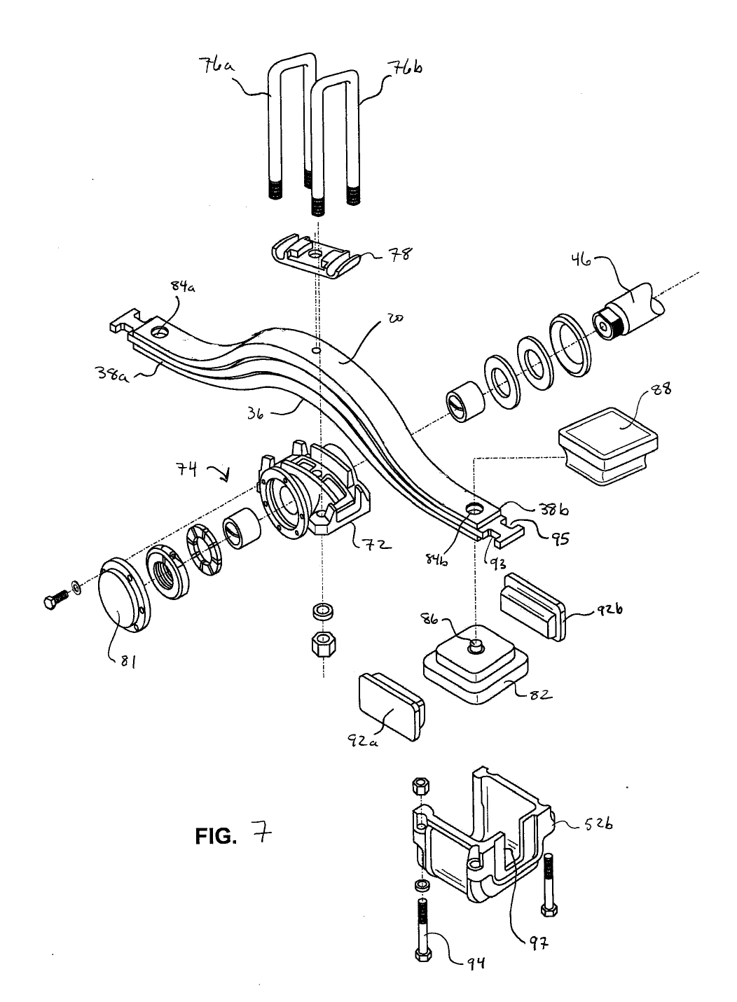

An example of suitable dimensions and a profile for the middle leaf spring 24 is illustrated in FIGS. 6A and 6B with reference to Table 2. For clarity, leaf spring 24 is illustrated in FIGS. 6A and 6B prior to being formed into the shape illustrated in FIGS. 2-4.

TABLE 2
Middle Spring Dimensions

| FIGS. 6A and 6B | Inches |
|---|---|
| a, a′ | 0.788 |
| b, b′ | 11.0 |
| c, c′ | 0.788 |
| d, d′ | 1.001 |
| e, d′ | 1.266 |
| f, f′ | 1.494 |
| g | 1.750 |
| h, h′ | 17.0 |
| i, i′ | 4.50 |
| j, j′ | 32.50 |
| k, k′ | 17.50 |
| l, l′ | 12.50 |
| m, m′ | 7.50 |
| n | 65.0 |
| o, o′ | 29⅝ |
| p, p′ | 1.875 |

It should be understood that the dimensions of Tables 1 and 2 are examples only, and that they may be varied depending on the spring material, application and corresponding strength required by the springs. For example, maximum thickness g of FIGS. 5A and 6A preferably ranges from 1.5 inches to 2.0 inches in thickness.

The material used for the production of the three leaf springs 22, 24 and 26 is a form of a standard SAE material grade with the hardenability and grain refining alloy elements slightly modified to meet the needs of the heat treatment process of the thicker cross sections of the leaves. More specifically, in a preferred embodiment, the alloys of a traditional SAE material, preferably SAE 4161 steel, are modified to achieve the hardenability and the grain refining needed. The molybdenum from the traditional SAE 4161 steel is lowered to avoid cracking. The carbon content is also altered (reduced) from the traditional SAE grades for the hardenability needs. Vanadium content is increased and niobium (columbium) is added for grain refining which improves the durability (fatigue life). An example of a preferred composition of the material (“4163ModV”) is provided in Table 3.

TABLE 3
Leaf Spring Steel Alloy Composition

| Chemical Composition | 4163ModV |
|---|---|
| Carbon (C) | 0.56/0.64 |
| Manganese (Mn) | 0.75/1.00 |
| Phosphorus (P) | 0.035 Max |
| Sulphur (S) | 0.040 Max |
| Silicon (Si) | 0.15/0.35 |
| Chromium (Cr) | 0.70/0.90 |
| Vanadium (V) | 0.04/0.06 |
| Molybdenum (Mo) | 0.09/0.20 |
| Copper (Cu) | 0.35 Max |
| Nickel (Ni) | 0.25 Max |
| Aluminum (Al) | 0.015 max |
| Tin (Sn) | 0.015 Max |
| Columbium (Cb)- | 0.01/0.035 |
| Niobium (Nb) | |

As such, the leaf spring alloyed material includes 0.56%-0.64% by weight of carbon, 0.09-0.20% by weight of molybdenum, 0.04-0.06% by weight of vanadium, 0.01-0.035% by weight of niobium, and other metals in an Iron base.

The Jominy Hardenability specifications of the leaf spring steel preferably are as illustrated in Table 4.

TABLE 4
Jominy Hardenability of
Leaf Spring Steel Alloy

| | |
|---|---|
| J2 Depth | 60 Rc min, 65 Rc max |
| J4 Depth | 60 Rc min, 65 Rc max |
| J6 Depth | 60 Rc min, 65 Rc max |
| J8 Depth | 60 Rc min, 65 Rc max |
| J10 Depth | 59 Rc min, 65 Rc max |
| J12 Depth | 59 Rc min, 64 Rc max |
| J14 Depth | 58 Rc min, 64 Rc max |
| J16 Depth | 56 Rc min, 64 Rc max |
| J20 Depth | 53 Rc min, 63 Rc max |

An exploded view of a tandem suspension system featuring the leaf spring assembly 20 of FIGS. 2-4 is illustrated in FIG. 7, while an assembled view is shown in FIG. 8. The suspension system is mounted to the frame of a vehicle, as shown in FIG. 4, by a trunnion pivot shaft mounting bracket 44 that supports the vehicle frame rail 42 on a trunnion pivot shaft 46. With reference to FIGS. 7 and 8, the trunnion pivot shaft 46 is received by the spring saddle 72 of trunnion mounting assembly 74. The spring saddle 72 is secured to the underside of the seat 36 of the leaf spring assembly via U-bolts 76a and 76b and top member 78. The clamping force from the U-bolts 76a and 76b holds the leaf spring assembly together after the U-bolts are torqued. As a result, the load from the vehicle and cargo is focused on the seat of the leaf spring assembly (i.e. at the center of the camel “hump”). A removable cover 81 attaches to the spring saddle 72 to permit access for maintenance.

As is illustrated in FIG. 7, a lower isolator or lower insulator block 82, constructed of rubber or another resilient material, is positioned under end portion 38b of the leaf spring assembly and is positioned within the bottom of axle clamp box 52b. End portions 38a and 38b of the leaf spring assembly feature apertures 84a and 84b, respectively. A locating pin 86 is positioned on top of the lower insulator block 82 and is received by the aperture 84b. An upper insulator block 88, also constructed of rubber or another resilient material, features a downward extending locating pin (not shown) that is also received within the aperture 84b. Upper insulator block 88 and spacers 92a and 92b are also received within the axle clamp box 52b. As a result, end portion 38b of the leaf spring assembly is positioned and supported in the axle clamp box 52b by upper and lower insulator blocks 88 and 82. The tip of leaf spring assembly end portion 38b is provided with notches 93 and 95 which are sized to be received within slot 97 of the axle clamp box 52b.

As is known by those skilled in the art, a drive axle (48b in FIG. 4) is clamped to the top of the upper insulator block 88 and axle clamp box 52b by brackets that are attached to the axle housing and engaged by nuts and bolts 94. Alternatively, the nuts and bolts may engage a plate or member positioned on top of the axle housing, or U-bolts may be substituted for bolts 94 to clamp the axle in place. Other clamping methods known in the art may alternatively be used as well. As a result, the vehicle axle is resiliently attached to the leaf spring assembly.

While only one axle clamp box 52b is shown in FIGS. 7 and 8, it should be clear to those skilled in the art that another axle clamp box and associated components and axle are provided at the other end portion 38a of the leaf spring assembly. It should also be understood that a mirror image of the suspension system of FIGS. 7 and 8 is positioned on the other side of the truck.

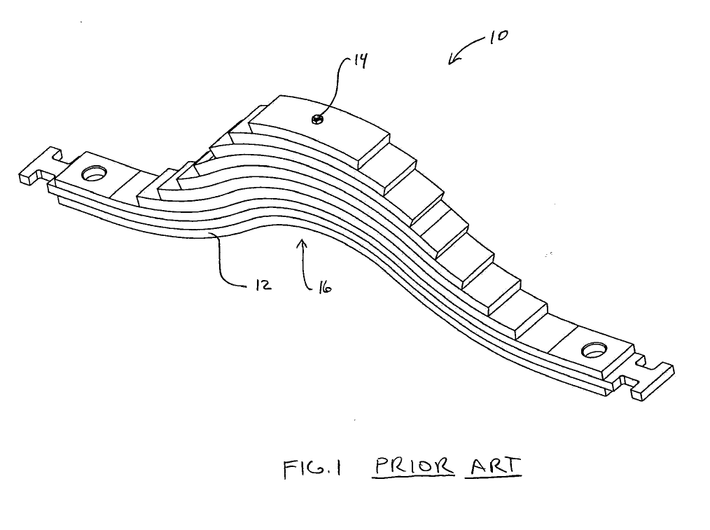

In view of the above, the leaf spring assembly of FIGS. 2-4 replaces the prior art leaf spring assembly (illustrated in FIG. 1) in a camelback suspension system such as the one shown in FIGS. 7 and 8 or in U.S. Pat. No. 5,119,543, the contents of which are hereby incorporated by reference.

As noted previously, depending on the axle rated capacity and the axle spacing, there are typically eight to twelve leaf springs in the leaf spring assembly (FIG. 1) used in prior art camelback suspensions. These leaf springs have various leaf thicknesses ranging from 0.625, 0.788, 0.999 and/or 1.205 inches. As illustrated and described above, the leaf spring of FIGS. 2-8 replaces these various combinations with three leaves preferably of 1.50, 1.625, 1.75 or 2.0 inches thickness. By using such a leaf spring assembly and tandem suspension, overall weight savings ranging from 30% less for the heaviest version up to 40% less for the lighter version are possible.

The stacked, tapered leaves of the invention described above with reference to FIGS. 2-8 also lend themselves to the post heat treatment process of stress peening, which improves the durability of the assembly by as much as two times over the conventional shot peening typically used in the manufacture of the prior art leaf spring assembly of FIG. 1. Preferably, a quenching process is used during production of the material used in the leaves of the leaf spring assembly of FIGS. 2-8, as well as a shot peening machine. The quenching is for improving the hardenability of the material and the peening is for improving the durability of the material. The peener preferably features wheels blasting the springs on the critical areas where fatigue cracking normally initiates.

While the preferred embodiments of the invention have been shown and described, it will be apparent to those skilled in the art that changes and modifications may be made therein without departing from the spirit of the invention, the scope of which is defined by the appended claims.

What is claimed is:

1. A leaf spring assembly for a suspension system of a vehicle comprising:
a) a plurality of leaf springs secured together so as to form a central seat adapted to be mounted to a chassis of the vehicle, a first end portion adapted to be mounted to a first axle of the vehicle and a second end portion adapted to be mounted to a second axle of the vehicle; and
b) each of said plurality of leaf springs featuring a central arcuate section and a pair of end sections, where a thickness of the leaf spring is at a maximum in the central arcuate section and tapers down in thickness towards the pair of end sections so that a constant stress results in a material of the leaf spring along at least a portion of the leaf spring when the leaf spring assembly is used in the suspension system.

2. The leaf spring assembly of claim 1 wherein each leaf spring features a minimum thickness in each end section.

3. The leaf spring assembly of claim 2 wherein the maximum thickness of each of said plurality of leaf springs is 1.5 to 2.0 inches and the minimum thickness is approximately 0.75 inches.

4. The leaf spring assembly of claim 1 wherein the pair of end sections of each leaf spring are generally straight.

5. The leaf spring assembly of claim 1 wherein the central arcuate section and pair of end sections of each of said plurality of leaf springs each feature an area having a generally constant thickness.

6. The leaf spring assembly of claim 1 wherein each of said plurality of leaf springs features a generally constant width.

7. The leaf spring assembly of claim 1 wherein each of said plurality of leaf springs is constructed of a steel alloy having 0.56%-0.64% by weight of carbon, 0.09-0.20% by weight of molybdenum, 0.04-0.06% by weight of vanadium, 0.01-0.035% by weight of niobium, and other metals in an Iron base.

8. The leaf spring assembly of claim 1 wherein the maximum thickness of each of said plurality of leaf springs is 1.5 to 2.0 inches.

9. A leaf spring for use in a suspension system of a vehicle comprising a central arcuate section adapted to be mounted to a chassis of the vehicle, a first end section adapted to be mounted to a first axle of the vehicle and a second end section adapted to be mounted to a second axle of the vehicle, where a thickness of the leaf spring is at a maximum in the central arcuate section and tapers down in thickness towards the first and second end sections so that a constant stress results in a material of the leaf spring along at least a portion of the leaf spring when the leaf spring is used in the suspension system.

10. The leaf spring of claim 9 wherein the leaf spring features a minimum thickness in each of the first and second end sections.

11. The leaf spring of claim 10 wherein the maximum thickness of the leaf spring is 1.5 to 2.0 inches and the minimum thickness is approximately 0.75 inches.

12. The leaf spring of claim 9 wherein the first and second end sections of the leaf spring are generally straight.

13. The leaf spring of claim 9 wherein the central arcuate section and the first and second end sections each feature an area having a generally constant thickness.

14. The leaf spring of claim 9 wherein a width of the leaf spring is generally constant.

15. The leaf spring of claim 9 wherein the leaf spring is constructed of a steel alloy having 0.56%-0.64% by weight of carbon, 0.09-0.20% by weight of molybdenum, 0.04-0.06% by weight of vanadium, 0.01-0.035% by weight of niobium, and other metals in an Iron base.

16. The leaf spring of claim 9 wherein the maximum thickness is 1.5 to 2.0 inches.

17. A tandem suspension system for a vehicle having a frame, a first axle and a second axle comprising:
a) a trunnion pivot shaft adapted to be mounted to the frame of the vehicle;
b) a leaf spring assembly including:
i. a plurality of leaf springs secured together so as to form a central seat that is mounted to the trunnion pivot shaft, a first end portion and a second end portion;
ii. each of said plurality of leaf springs featuring a central arcuate section and a pair of end sections, where a thickness of the leaf spring is at a maximum in the central arcuate section and tapers down in thickness towards the pair of end sections so that a constant stress results in a material of the leaf spring along at least a portion of each leaf spring when the leaf spring assembly is used in the suspension system;
c) a first insulator block connected to the first end portion of the leaf spring assembly;
d) a second insulator block connected to the second end portion of the leaf spring assembly;
e) a first axle clamp box receiving the first insulator block and adapted to connect to the first axle of the vehicle; and
f) a second axle clamp box receiving the second insulator block and adapted to connect to the second axle of the vehicle.

18. The suspension system of claim 17 wherein each of said plurality of leaf springs is constructed of a steel alloy having 0.56%-0.64% by weight of carbon, 0.09-0.20% by weight of molybdenum, 0.04-0.06% by weight of vanadium, 0.01-0.035% by weight of niobium, and other metals in an Iron base.

19. The suspension system of claim 17 wherein each leaf spring features a minimum thickness in each end section.

20. The suspension system of claim 19 wherein the maximum thickness of each of said plurality of leaf springs is 1.5 to 2.0 inches and the minimum thickness is approximately 0.75 inches.
